(19) United States
(12) Patent Application Publication
(10) Pub. No.: US 2002/0097867 A1
(43) Pub. Date: Jul. 25, 2002

(54) Communication system

(76) Inventor: Anthony V. Bartram, Welwyn Garden City (GB)

Correspondence Address: Kirschstein, Ottinger, Israel & Schiffmiller, P.C., 489 Fifth Avenue, New York, NY, 10017-6105, US

(21) Appl. No.: 09/989,087

(22) Filed: Nov. 21, 2001

(30) Foreign Application Priority Data
Nov. 21, 2000 (GB) 0028369.7

(51) Int. Cl. H04K 1/04

(52) U.S. Cl. 380/37

(57) ABSTRACT

A communication system includes at one end of a communications channel, a first cipher generator for generating a succession of ciphers, the generator including a first random number generator for generating a sequence of random numbers, each cipher of the succession of ciphers being based on a respective successive portion of the sequence of random numbers, and a symmetric encryptor for encrypting successive amounts of information for transmission to the other end of the channel, each amount of information being encrypted using a respective one of the succession of ciphers. At the other end of the channel, the system includes a second cipher generator for generating in synchronism with the first cipher generator the same succession of ciphers as the first cipher generator, the second cipher generator including a second random number generator for generating the same sequence of random numbers as the first random number generator, and a symmetric decryptor for decrypting the encrypted successive amounts of information received from the one end of the channel, each amount of information being decrypted using the same respective one of the succession of ciphers as was used to encrypt it by the encryptor at the one end of the channel.

### BACKGROUND OF THE INVENTION

This invention relates to a communication system.

More particularly, the invention relates to a communication system wherein a message is sent in encrypted form over a communication channel.

Communication systems are known wherein so called “symmetric encryption” is used to encrypt the message. In symmetric encryption, the cipher key used to encrypt the message is the same as the cipher key used to decrypt the message. Symmetric encryption has the disadvantage that it is not particularly secure. Firstly, before secure communication using the cipher can take place, it is necessary that the cipher key be communicated to the intended message recipient. Such cipher key communication, if intercepted, renders insecure all subsequent communication using the cipher. Secondly, symmetric encryption is susceptible to analysis of actual messages sent using the cipher, for the purpose of discovering the cipher key. Symmetric encryption has the advantage that it requires relatively low computational power to implement.

Communication systems are known wherein so called public key cryptography is used. In public key cryptography, the cipher key used to encrypt the message is different to the one used to decrypt the message, i.e., the encryption is asymmetric. A prospective message recipient is assigned both the encrypt and decrypt keys of a cipher. The encrypt key is made available to the public, i.e., to anyone wishing to send a message to the recipient, and is termed the public key. The decrypt key is kept secret by the recipient, and is termed the private key. For secure communication to take place, a person wishing to send a message to the recipient, encrypts the message with the recipient's public key, and transmits it to the recipient. The recipient then decrypts the message using his private key. Thus, in public key cryptography, there is no need for communication by a message sender, of a key required for message decryption. Public key cryptography suffers from the disadvantage that it requires relatively high computational power to implement. Further, if the numbers constituting the public/private keys are not sufficiently large, the encryption is susceptible to analysis of actual messages sent using the cipher, for the purpose of discovering the cipher keys.

A hybrid of symmetric encryption and public key cryptography is known, wherein symmetric encryption is used for message transmission, but prior to message transmission the encrypt/decrypt cipher key is sent using public key cryptography. However, since all messages are sent using symmetric encryption, this hybrid method is still particularly vulnerable to analysis of actual messages sent using the cipher, for the purpose of discovering the cipher key.

### SUMMARY OF THE INVENTION

According to a first aspect of the present invention there is provided a communication system comprising: a communication channel; at one end of said channel: (i) a first cipher generator for generating a succession of ciphers, said generator including a first random number generator for generating a sequence of random numbers, each cipher of said succession of ciphers being based on a respective successive portion of said sequence of random numbers; and (ii) a symmetric encryptor for encrypting successive amounts of information for transmission to the other end of said channel, each amount of information being encrypted using a respective one of said succession of ciphers; and, at the other end of said channel: (i) a second cipher generator for generating in synchronism with said first cipher generator the same said succession of ciphers as the first cipher generator, said second cipher generator including a second random number generator for generating the same said sequence of random numbers as said first random number generator; and (ii) a symmetric decryptor for decrypting the encrypted successive amounts of information received from said one end of said channel, each amount of information being decrypted using the same respective one of said succession of ciphers as was used to encrypt it by said encryptor at said one end of said channel.

Preferably, the system further comprises: at said one end of said channel: (i) means for generating a seed sequence of random numbers, which seed sequence is used by said first random number generator to generate said sequence of random numbers; and (ii) an asymmetric encryptor for encrypting said seed sequence for transmission over said channel to said other end of the channel; and, at said other end, an asymmetric decryptor for decrypting the encrypted seed sequence received from said one end of the channel, said second random number generator using the decrypted seed sequence to generate said same sequence of random numbers as said first random number generator. Suitably, said asymmetric encryptor and said asymmetric decryptor employ public key cryptography.

Preferably, the supply to said symmetric encryptor of each of said successive amounts of information, is signalled to both said first and second cipher generators, whereupon the generators synchronously generate the same next cipher in said succession of ciphers.

Preferably, said symmetric encryptor is a block symmetric encryptor and said symmetric decryptor is a block symmetric decryptor.

Preferably, said first and second cipher generators include: first switching means for receiving said sequence of random numbers; a plurality of subsidiary cipher generators, said first switching means switching said successive portions of said sequence of random numbers between said plurality of subsidiary cipher generators, each cipher generated by a subsidiary cipher generator being based on a respective said random number sequence portion switched to it by said first switching means; and second switching means for switching in turn between said subsidiary cipher generators to provide said succession of ciphers.

Preferably, in a system according to the previous paragraph, said plurality of subsidiary cipher generators is two subsidiary cipher generators, and said first and second switching means switch simultaneously but to different ones of said two subsidiary cipher generators.

Preferably, in a system according to the previous paragraph, or the previous paragraph but one, each said subsidiary cipher generator comprises: third switching means; a plurality of exclusive OR (XOR) gates, said third switching means switching random numbers received by the subsidiary cipher generator between said plurality of XOR gates; and a plurality of registers, one in respect of each XOR gate, each register both receiving the output of, and providing a further input to, its respective XOR gate, the contents of said plurality of registers constituting the cipher generated by the subsidiary cipher generator.

According to a second aspect of the present invention there is provided a communication method comprising the steps of: at one end of a communication channel: (i) generating a first sequence of random numbers; (ii) generating a succession of ciphers, each cipher being based on a respective successive portion of said first sequence of random numbers; and (iii) symmetrically encrypting successive amounts of information for transmission to the other end of said channel, each amount of information being encrypted using a respective one of said succession of ciphers; and, at the other end of said channel: (i) generating the same said first sequence of random numbers; (ii) in synchronism with the generation of said succession of ciphers at said one end of said channel (31), generating the same said succession of ciphers at said other end of the channel (31); and (iii) symmetrically decrypting the encrypted successive amounts of information received from said one end of said channel, each amount of information being decrypted using the same respective one of said succession of ciphers as was used to encrypt it at said one end of said channel.

Preferably, said method further comprises the steps of: at said one end of said channel: (i) generating a seed sequence of random numbers, which seed sequence is used to generate said first sequence of random numbers; and (ii) asymmetrically encrypting said seed sequence for transmission to said other end of said channel; and, at said other end, asymmetrically decrypting the encrypted seed sequence received from said one end of the channel, the decrypted seed sequence being used to generate said same said first sequence of random numbers. Suitably, said asymmetric encryption and said asymmetric decryption employ public key cryptography.

Preferably, in said method, the supply for symmetric encryption of each of said successive amounts of information, is signalled, whereupon there is the synchronous generation at each end of said channel of the same next cipher in said succession of ciphers.

Preferably, in said method, said symmetric encryption is block symmetric encryption and said symmetric decryption is block symmetric decryption.

According to a third aspect of the present invention there is provided a cipher generator for generating a succession of ciphers, said generator comprising: a random number generator for generating a sequence of random numbers; first switching means for receiving said sequence of random numbers; a plurality of subsidiary cipher generators, said first switching means switching successive portions of said sequence of random numbers between said plurality of subsidiary cipher generators, each cipher generated by a subsidiary cipher generator being based on a respective said random number sequence portion switched to it by said first switching means; and second switching means for switching in turn between said subsidiary cipher generators to provide said succession of ciphers.

Preferably, in said generator, said plurality of subsidiary cipher generators is two subsidiary cipher generators, and said first and second switching means switch simultaneously but to different ones of said two subsidiary cipher generators.

Preferably, in said generator, each said subsidiary cipher generator comprises: third switching means; a plurality of exclusive OR (XOR) gates, said third switching means switching random numbers received by the subsidiary cipher generator between said plurality of XOR gates; and a plurality of registers, one in respect of each XOR gate, each register both receiving the output of, and providing a further input to, its respective XOR gate, the contents of said plurality of registers constituting the cipher generated by the subsidiary cipher generator.

### BRIEF DESCRIPTION OF THE DRAWINGS

A communication system in accordance with the present invention will now be described, by way of example, with reference to the accompanying drawings, in which:

FIG. 1 is a block schematic diagram of the system;

FIG. 2 is a schematic circuit diagram of first/second cipher generators of the system of FIG. 1; and

FIG. 3 is a schematic circuit diagram of a symmetric encryptor/decryptor of the system of FIG. 1.

### DETAILED DESCRIPTION OF THE PREFERRED EMBODIMENTS

The communication system will be described by describing its operation to securely transmit the message Mp. In the description to follow, each message character consists of 1 byte, i.e., 8 binary digits or bits. It is therefore possible to represent 256 different characters, each character being represented by a number 0 to 255. Messages are transmitted in the form of pairs of bytes, i.e., in blocks of two characters or 16 bits. In the example below, the one character message Mp=65=1000001 is transmitted. This message is transmitted as 0000000001000001.

Prior to sending the message, the communication system must be initialized. This takes place as follows.

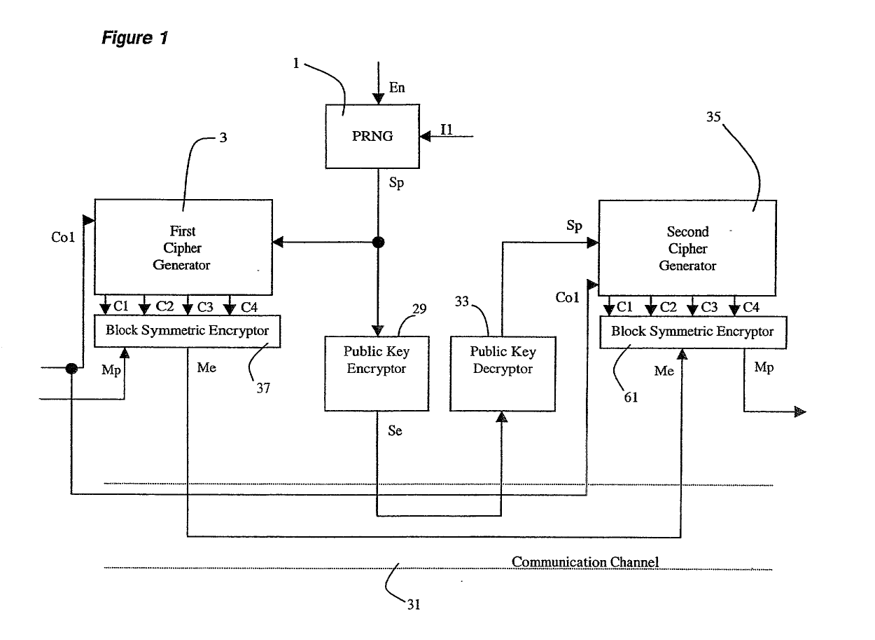

Referring to FIG. 1, entropy En in the form of a series of random numbers, is supplied to first pseudo random number generator (PRNG) 1. Entropy En may be derived from any suitable source, e.g., the content of a display screen at the time of initialization combined with the current time and date. In this example, En=12, 5, 100, 3, 10, 9, 8, 2, 7. An initialise signal I1 is also supplied to PRNG 1, to cause it to utilize, in known manner, En as a random number generating seed. Series of random numbers Sp results, and passes to first cipher generator 3. In this example, Sp=5, 3, 1, 5, 1.

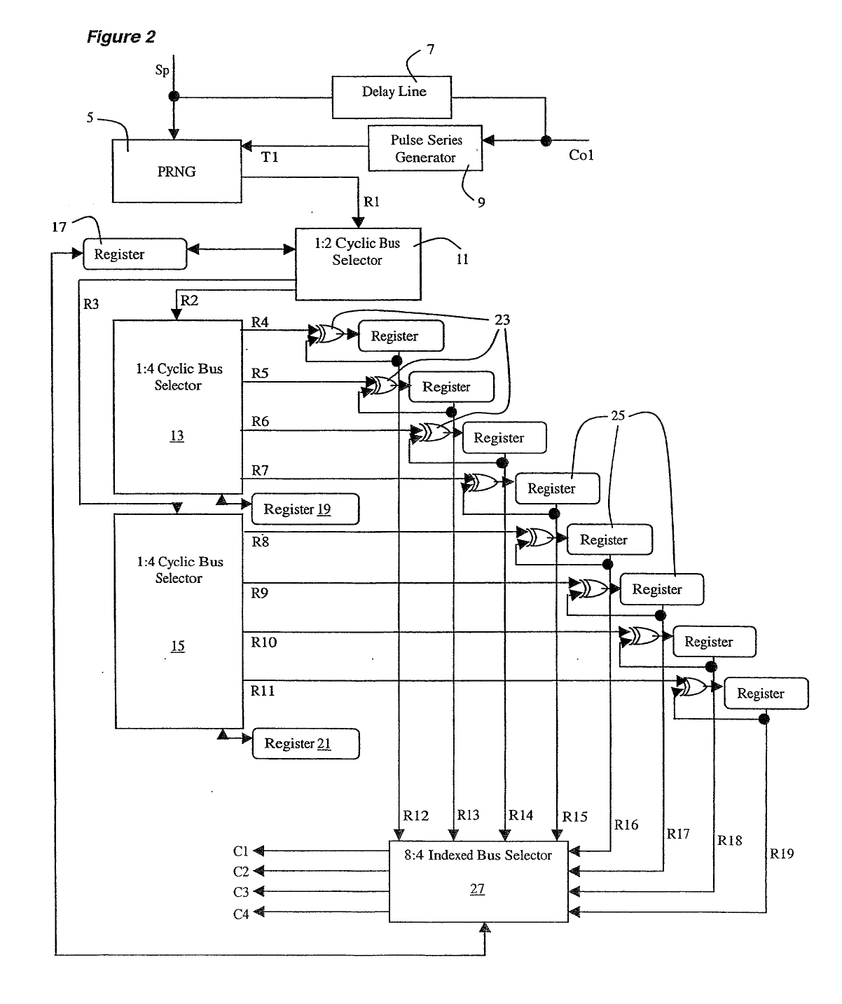

Referring also to FIG. 2, in generator 3, Sp is supplied to both second PRNG 5, and, via delay line 7, to pulse series generator 9. During initialization, no signal Co1 is supplied to generator 9. In respect of each signal received via delay line 7, generator 9 generates four pulses T1. Thus, in this example, in response to Sp=5, 3, 1, 5, 1, generator 9 generates twenty pulses. These are supplied to PRNG 5. PRNG 5 utilizes Sp as a random number generating seed. It generates one random number in response to the receipt of each trigger pulse T1 from generator 9. In this example, PRNG 5 generates twenty random numbers or characters R1=100, 50, 30, 80, 90, 60, 40, 20, 12, 18, 56, 78, 34, 11, 23, 54, 44, 35, 42, 99.

1:2 cyclic bus selector 11 receives R1, and alternately supplies every four received characters to 1:4 cyclic bus selectors 13, 15. It does this by indexing the count in register 17 each time it supplies a character to either of bus selectors 13, 15. Register 17 commences counting at 0, and when it reaches 3 it causes bus selector 11 to switch to supply whichever of bus selectors 13, 15 it is not currently supplying. Thus, if it is assumed bus selector 11 commences supplying bus selector 13, then the above example R1 gives rise to the following sequence of R2/R3s supplied respectively to bus selectors 13/15: R2=100, 50, 30, 80; R3=90, 60, 40, 20; R2=12, 18, 56, 78; R3=34, 11, 23, 54; and R2=44, 35, 42, 99.

Operating in analogous manner to bus selector 11, each bus selector 13, 15 cycles the random numbers it receives around its four outputs, supplying each received number to the next of its four outputs. Each bus selector 13, 15 does this by indexing the count of its respective register 19, 21, which registers count only one increment before causing switching. Thus, the following outputs R4-R11 of bus selectors 13, 15 will be produced in response the above example sequence of R2/R3s: R4=100, 12, 44; R5=50, 18, 35; R6=30, 56, 42; R7=80, 78, 99; R8=90, 34; R9=60, 11; R10=40, 23; and R1=20, 54.

Each of outputs R4-R11 is supplied to a respective exclusive-OR (XOR) gate 23, each of which gates in turn supplies a respective register 25. Each output R4-R11 forms one input to its respective XOR gate 23. The other input to each gate 23 is formed by the current contents of that gate's respective register 25. Thus, the following outputs R12-R19 of registers 25 will be produced in response to the above example outputs R4-R11 of bus selectors 13, 15: R12=100, 104, 68; R13=50, 32, 3; R14=30, 38, 12; R15=80, 30, 125; R16=90, 120; R17=60, 55; R18=40, 63; and R19=20, 20.

Outputs R12-R19 are supplied to 8:4 indexed bus selector 27. Register 17, in addition to controlling the switching of bus selector 11, also controls the switching of bus selector 27, which selects its four outputs C1-C4 by switching between set of four inputs R12-R15 and set of four inputs R16-R19. Register 17, when switching bus selector 11 to supply bus selector 13, simultaneously switches bus selector 27 to pass R16-R19 to C1-C4. Similarly, register 17, when switching bus selector 11 to supply bus selector 15, simultaneously switches bus selector 27 to pass R12-R15 to C1-C4. In this manner, whilst a current C1-C4 are present as outputs of bus selector 27, the next C1-C4 are being created, i.e., creation of the next C1-C4 occurs in parallel with the current C1-C4. C1-C4 constitute the output of first cipher generator 3. 1:4 cyclic bus selector 13, register 19, and the XOR gates 23 and registers 25 supplied by bus selector 13, together, can be considered a subsidiary cipher generator of cipher generator 3. The same applies in respect of 1:4 cyclic bus selector 15, register 21, and the XOR gates 23 and registers 25 supplied by bus selector 15. Bus selectors 11, 27 switch between these two subsidiary ciphers generators, bus selector 11 switching to supply one, while bus selector 27 switches to take the output of the other. Since, in this example, R12-R15 are currently being created (see above mentioned outputs R4-R11, R4-R7 each have one more number than R8-R11) the current C1-C4 comprise R16-R19, i.e., C1=120, C2=55, C3=63 and C4=20.

Returning to the output Sp of PRNG 1, this is also supplied to public key encryptor 29, which utilizes the known RSA (Rivest-Shamir-Adleman) cipher to encrypt Sp. In this example, the public key/private key pair of the RSA cipher is described by e=3, n=33 and d=7, where e and n together form the public key, and d is the private key. Thus, each value of Sp=5, 3, 1, 5, 1 is encrypted using the equation Se=Sp^{e} mod n, to give Se=26, 27, 1, 26, 1. The output Se of encryptor 29 is transmitted via communication channel 31 to public key decryptor 33, where it is decrypted using the equation Sp=Se^{d} mod n, to recreate Sp=5, 3, 1, 5, 1. The output Sp of decryptor 33 is supplied to second cipher generator 35. The circuitry of second cipher generator 35 is precisely the same as first cipher generator 3 shown in FIG. 2. Sp is used by second cipher generator 35 in precisely analogous manner to first cipher generator 3 to generate the same C1-C4, i.e., C1=120, C2=55, C3=63 and C4=20.

This completes initialization of the communication system. Sending of the message Mp=65 will now be described.

Supply of the message Mp for transmission, is signalled to both first and second cipher generators 3, 35 by a pulse Co1 (no signal Sp is used in transmission of Mp, signal Sp is only used in system initialization). The following then occurs in both cipher generators 3, 35. In response to pulse Co1, pulse series generator 9 supplies four pulses to PRNG 5, which in turn generates four random numbers R1=87, 71, 8, 200. Register 17 switches bus selector 11 to copy R1 to R3, to supply bus selector 15. This occurs because the last four numbers (44, 35, 42, 99) routed by bus selector 11 were copied to R2, to supply bus selector 13. Register 17, at the same time as switching bus selector 11, switches 8:4 indexed bus selector 27. Hence, bus selector 27 now copies R12-R15 to C1-C4 in place of R16-R19. Thus, now, in respect of both cipher generators, C1=68, C2=3, C3=12 and C4=125.

The message Mp itself is supplied to block symmetric encryptor 37, where it is encrypted using C1-C4 received from cipher generator 3, as will now be explained.

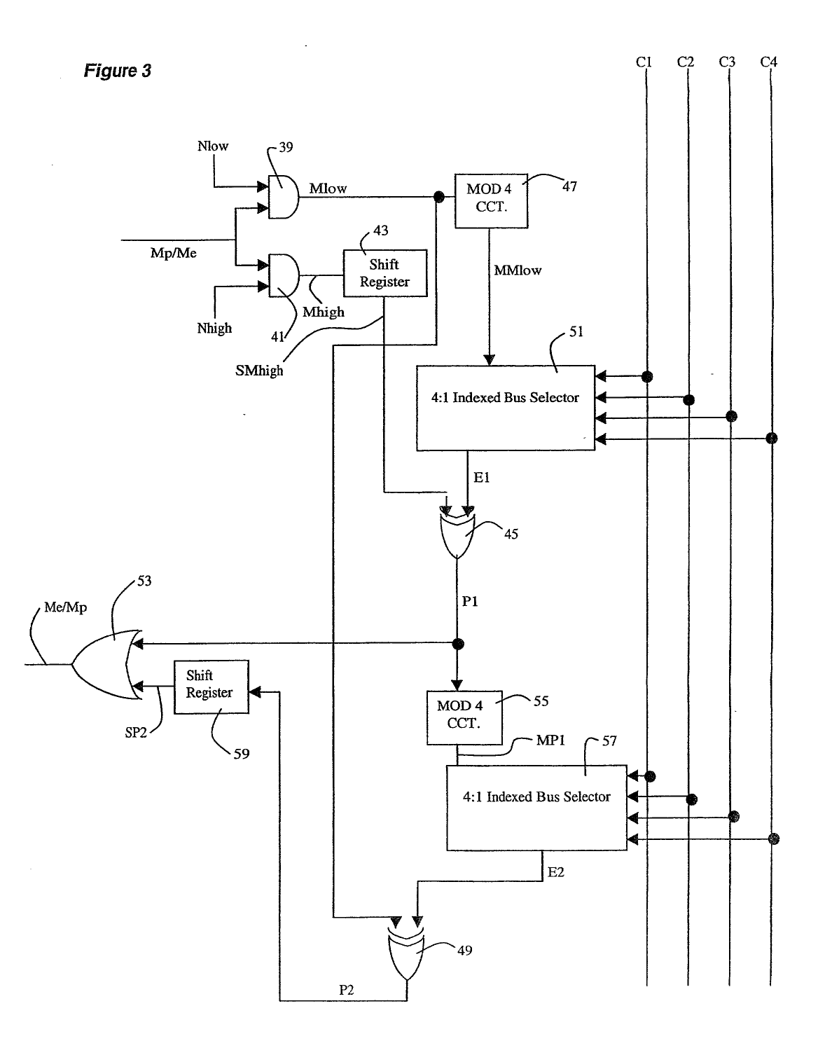

Referring also to FIG. 3, Mp is supplied to an input of each AND gate 39, 41. The other input to gate 39, Nlow=0000000011111111 (255). The other input to gate 41, Nhigh=1111111100000000 (65280). The function of gates 39, 41 is to extract the first and second 8 bit characters respectively of each two character message block (see above). Now, Mp is transmitted as 0000000001000001, therefore the output Mlow of AND gate 39 will be 0000000001000001 (i.e. Mp=65), and the output Mhigh of AND gate 41 will be 0000000000000000 (since Mp is a one character message).

Shift register 43 shifts Mhigh to the right by 8 bits to create SMhigh=0000000000000000, which is supplied to one input of XOR gate 45. Mlow is supplied to both MOD 4 circuit 47 and one input of XOR gate 49. MOD 4 circuit 47 computes MMlow=Mlow mod 4=1, and supplies this to 4:1 indexed bus selector 51. Bus selector 51 is also supplied with the output C1-C4 (68, 3, 12, 125) of first cipher generator 3. Bus selector 51 uses MMlow to select one of C1-C4. In this regard, it is to be appreciated that MMlow will always be one of 0, 1, 2 or 3. MMlow=0 causes bus selector 51 to select C1, 1 selects C2, 2 selects C3, and 3 selects C4. C2=3 is therefore selected, and supplied as signal E1 to the other input of XOR gate 45.

XOR gate 45 XORs together SMhigh=0 and E1=3 to provide output P1=3, which is supplied to both one input of OR gate 53 and MOD 4 circuit 55. MOD 4 circuit 55 computes MP1=P1 mod 4=3, supplies this to 4:1 indexed bus selector 57. The operation of bus selector 57 is precisely analogous to that of bus selector 51. Hence, C4=125 is selected, and supplied as signal E2 to the other input of XOR gate 49. XOR gate 49 XORs together Mlow=65 and E2=125 to provide output P2=60 (0000000000111100), which is supplied to shift register 59. Shift register 59 shifts P2 left by 8 bits, and supplies the result SP2=15360 to the other input of OR gate 53. OR gate 53 ORs together P1=3 and SP2=15360 to provide output Me=15363.

Me=15363 constitutes the encrypted version of Mp=65, and is transmitted over communication channel 31 to block symmetric decryptor 61. The circuitry of decryptor 61 is precisely the same as encryptor 37. As will now be explained, decryptor 61 operates in precisely analogous manner to encryptor 37, to decrypt Me=15363 to recreate Mp=65.

Me=15363 is supplied to AND gates 39, 41, which provide respectively outputs Mlow=0000000000000011 and Mhigh=0011110000000000. MOD 4 circuit 47 computes MMlow=Mlow mod 4=3, which causes bus selector 51 to select C4=125, which is copied to E1. Shift register 43 creates SMhigh=60. XOR gate 45 XORs SMhigh and E1 to provide P1=65. MOD 4 circuit 55 computes MP1=P1 mod 4=1, which causes bus selector 57 to select C2=3, which is copied to E2. XOR gate 49 XORs Mlow and E2 to provide P2=0. Shift register 59 creates SP2=0. OR gate 53 ORs P1 and SP2 to recreate original message Mp=65.

It will be appreciated that receipt of a further message Mp for transmission, will again be signalled to both first and second cipher generators 3, 35 by another pulse Co1. This will cause the generation by cipher generators 3, 35 of a new cipher or set of outputs C1-C4. Thus, this further message Mp will be encrypted with a different cipher to the first message. This repeated generation of a new cipher for every message Mp to be transmitted, provides for very secure communication. Although symmetric encryption is used for actual message transmission, the cipher key is new for every message sent. There is therefore only a relatively small amount of transmission using any given cipher key, thereby severely frustrating analysis of actual messages sent for the purpose of cipher key discovery. In addition, provided the pseudo random number generated by generator 5 is sufficiently complex, knowledge of the cipher key used for the transmission of one message, does not enable analysis to determine this pseudo random number, and hence the cipher keys for other messages sent.

Further, each message's cipher key is never transmitted. The cipher keys are generated independently and in synchronism at each end of the communication channel. This is achieved by the initial transmission, by secure public key cryptography, of a random number generating seed, which seed is then used in corresponding manner at each end of the communication channel to synchronously generate the message specific cipher keys. The one time sending of a random number generating seed by public key cryptography, does not provide a sufficient quantity of transmission to enable analysis of actual transmission, for the purpose of discovering the private decrypt key of the public key cryptography (and hence the random number generating seed). This is so even in the case where the numbers constituting the public/private keys are relatively small.

Further, relatively low power is required for implementation of the present invention, since symmetric encryption is used for all encryption apart from the one time encryption of the random number generating seed.

In the communication system described above by way of example, there is an encryptor 37 at the transmit end of the of the communication channel, and a decryptor 61 at the receive end. It is to be appreciated that, since the circuitry of these two elements is precisely the same, each could function, and in practice almost certainly would function, as both an encryptor and a decryptor, thereby enabling two way secure communication over communication channel 31. Of course, such two way communication would require the transmission over communication channel 31 of a signal corresponding to Co1, but in the opposite direction.

I claim:

1. A communication system comprising: a communication channel having ends;
at one end of said channel:
(i) a first cipher generator for generating a succession of ciphers, said generator including a first random number generator for generating a sequence of random numbers, each cipher of said succession of ciphers being based on a respective successive portion of said sequence of random numbers; and
(ii) a symmetric encryptor for encrypting successive amounts of information for transmission to the other end of said channel, each amount of information being encrypted using a respective one of said succession of ciphers; and,
at the other end of said channel:
(i) a second cipher generator for generating in synchronism with said first cipher generator the same said succession of ciphers as the first cipher generator, said second cipher generator including a second random number generator for generating the same said sequence of random numbers as said first random number generator; and
(ii) a symmetric decryptor for decrypting the encrypted successive amounts of information received from said one end of said channel, each amount of information being decrypted using the same respective one of said succession of ciphers as was used to encrypt it by said encryptor at said one end of said channel.

2. The system according to claim 1 further comprising:
at said one end of said channel:
(i) means for generating a seed sequence of random numbers, which seed sequence is used by said first random number generator to generate said sequence of random numbers; and
(ii) an asymmetric encryptor for encrypting said seed sequence for transmission over said channel to said other end of the channel; and,
at said other end of said channel:
(i) an asymmetric decryptor for decrypting the encrypted seed sequence received from said one end of the channel, said second random number generator using the decrypted seed sequence to generate said same sequence of random numbers as said first random number generator.

3. The system according to claim 2, wherein said asymmetric encryptor and said asymmetric decryptor employ public key cryptography.

4. The system according to claim 1, wherein a supply to said symmetric encryptor of each of said successive amounts of information, is signalled to both said first and second cipher generators, whereupon the generators synchronously generate the same next cipher in said succession of ciphers.

5. The system according to claim 1, wherein said symmetric encryptor is a block symmetric encryptor and said symmetric decryptor is a block symmetric decryptor.

6. The system according to claim 1, wherein said first and second cipher generators include:
first switching means for receiving said sequence of random numbers;
a plurality of subsidiary cipher generators, said first switching means switching said successive portions of said sequence of random numbers between said plurality of subsidiary cipher generators, each cipher generated by a subsidiary cipher generator being based on a respective said random number sequence portion switched to it by said first switching means; and
second switching means for switching in turn between said subsidiary cipher generators to provide said succession of ciphers.

7. The system according to claim 6, wherein said plurality of subsidiary cipher generators is two subsidiary cipher generators, and said first and second switching means switch simultaneously but to different ones of said two subsidiary cipher generators.

8. The system according to claim 6, wherein each said subsidiary cipher generator comprises:
third switching means;
a plurality of exclusive OR (XOR) gates, said third switching means switching random numbers received by the subsidiary cipher generator between said plurality of XOR gates; and
a plurality of registers, one in respect of each XOR gate, each register both receiving the output of, and providing a further input to, its respective XOR gate, the contents of said plurality of registers constituting the cipher generated by the subsidiary cipher generator.

9. A communication method comprising the steps of:
at one end of a communication channel:
(i) generating a first sequence of random numbers;
(ii) generating a succession of ciphers, each cipher being based on a respective successive portion of said first sequence of random numbers; and
(iii) symmetrically encrypting successive amounts of information for transmission to the other end of said channel, each amount of information being encrypted using a respective one of said succession of ciphers; and,
at the other end of said channel:
(i) generating the same said first sequence of random numbers;
(ii) in synchronism with the generation of said succession of ciphers at said one end of said channel, generating the same said succession of ciphers at said other end of the channel; and
(iii) symmetrically decrypting the encrypted successive amounts of information received from said one end of said channel, each amount of information being decrypted using the same respective one of said succession of ciphers as was used to encrypt it at said one end of said channel.

10. The method according to claim 9, further comprising the steps of:
at said one end of said channel:
(i) generating a seed sequence of random numbers, which seed sequence is used to generate said first sequence of random numbers; and
(ii) asymmetrically encrypting said seed sequence for transmission to said other end of said channel; and,
at said other end of said channel:
(i) asymmetrically decrypting the encrypted seed sequence received from said one end of the channel, the decrypted seed sequence being used to generate said same said first sequence of random numbers.

11. The method according to claim 10, wherein said asymmetric encryption and said asymmetric decryption employ public key cryptography.

12. The method according to claim 9, wherein a supply for symmetric encryption of each of said successive amounts of information, is signalled, whereupon there is the synchronous generation at each end of said channel of the same next cipher in said succession of ciphers.

13. The method according to claim 9, wherein said symmetric encryption is block symmetric encryption and said symmetric decryption is block symmetric decryption.

14. A cipher generator for generating a succession of ciphers, said generator comprising:
a random number generator for generating a sequence of random numbers;
first switching means for receiving said sequence of random numbers;
a plurality of subsidiary cipher generators, said first switching means switching successive portions of said sequence of random numbers between said plurality of subsidiary cipher generators, each cipher generated by a subsidiary cipher generator being based on a respective said random number sequence portion switched to it by said first switching means; and
second switching means for switching in turn between said subsidiary cipher generators to provide said succession of ciphers.

15. The generator according to claim 14, wherein said plurality of subsidiary cipher generators is two subsidiary cipher generators, and said first and second switching means switch simultaneously but to different ones of said two subsidiary cipher generators.

16. The generator according to claim 14, wherein each said subsidiary cipher generator comprises:
third switching means;
a plurality of exclusive OR (XOR) gates, said third switching means switching random numbers received by the subsidary cipher generator between said plurality of XOR gates; and
a plurality of registers, one in respect of each XOR gate, each register both receiving the output of, and providing a further input to, its respective XOR gate, the contents of said plurality of registers constituting the cipher generated by the subsidiary cipher generator.
